(19) United States
(12) Patent Application Publication
(10) Pub. No.: US 2019/0185095 A1
(43) Pub. Date: Jun. 20, 2019

(54) Chainring Dust Plate and Mount

(71) Applicant: Thomas Michael Mutch, Coral Springs, FL (US)

(72) Inventor: Thomas Michael Mutch, Coral Springs, FL (US)

(21) Appl. No.: 15/847,779

(22) Filed: Dec. 19, 2017

(51) Int. Cl. B62J 13/00

(52) U.S. Cl. CPC B62J 13/00

(57) ABSTRACT

A dust plate mounted to a bicycle's downtube located in front of the chainring (crank) that reduces the amount of airborne particles from entering the drivetrain caused by the forward moving front tire while maintaining access to service the crank and/or chain.

### BACKGROUND OF THE INVENTION

Off-road bicycles, or mountain bikes experience some of the harshest conditions a drivetrain is pedaled through. Providing protection to the drivetrain by reducing the amount of dirt accumulated on it can potentially improve performance.

### FIELD OF THE INVENTION

This application is intended however not limited to off-road bicycles, or mountain bikes. It relates to plates or covers that are used to protect or reduce the amount of dirt from entering moving parts (specifically the crank area).

### BRIEF SUMMARY OF THE INVENTION

This dust plate is located in front of the chainring (crank) and acts as a shield to reduce airborne particles from entering the drivetrain caused by a forward moving front tire therefore reducing friction and increasing longevity for the rider and drivetrain.

### BRIEF DESCRIPTION OF THE VIEWS OF THE INVENTION

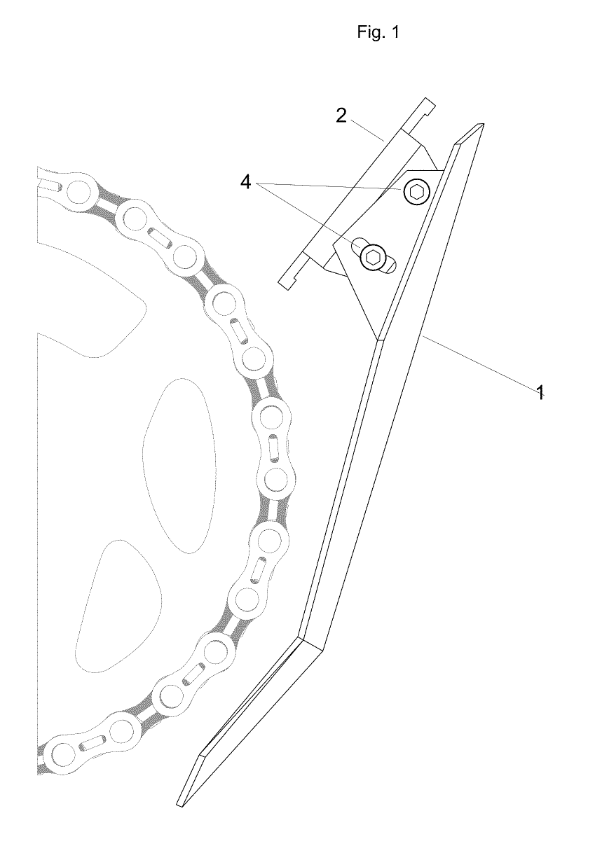

FIG. 1 illustrates right view of dust plate (angled) and mount B, with chainring and chain.

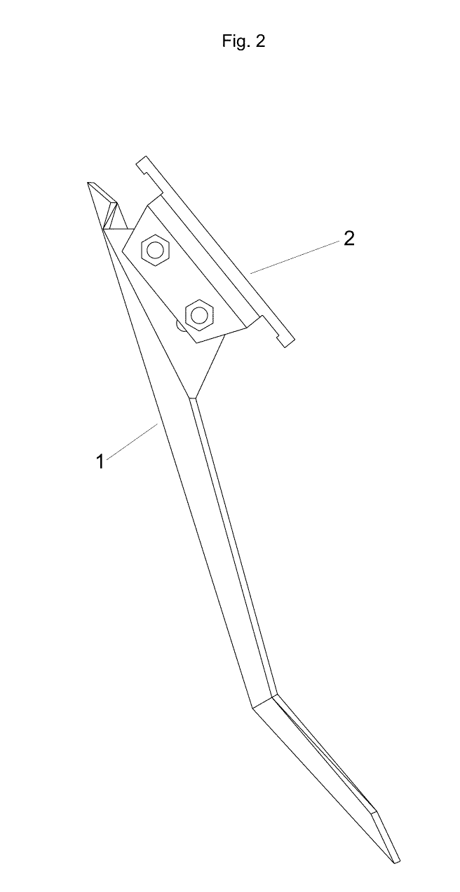

FIG. 2 illustrates left view of dust plate (angled) and mount B.

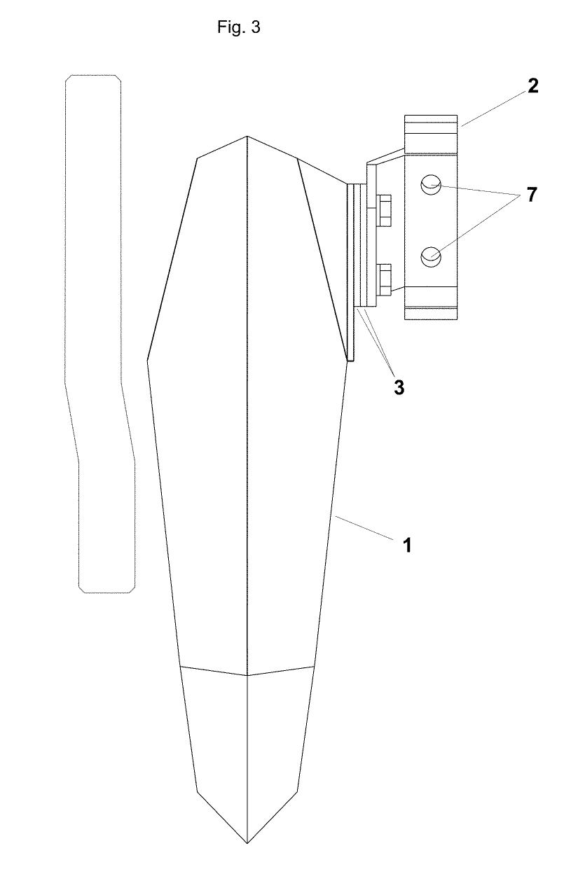

FIG. 3 illustrates front view of dust plate (angled) and mount B, with crankarm.

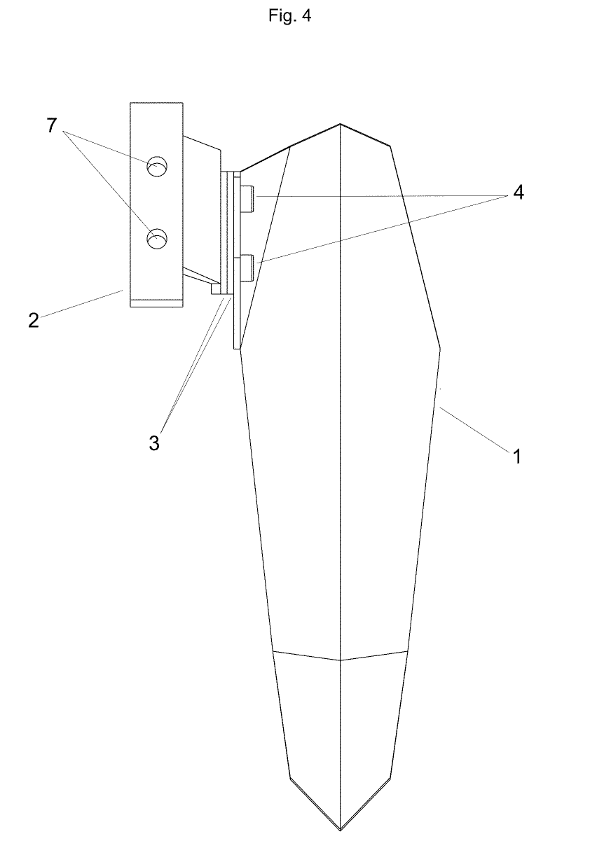

FIG. 4 illustrates back view of dust plate (angled) and mount B.

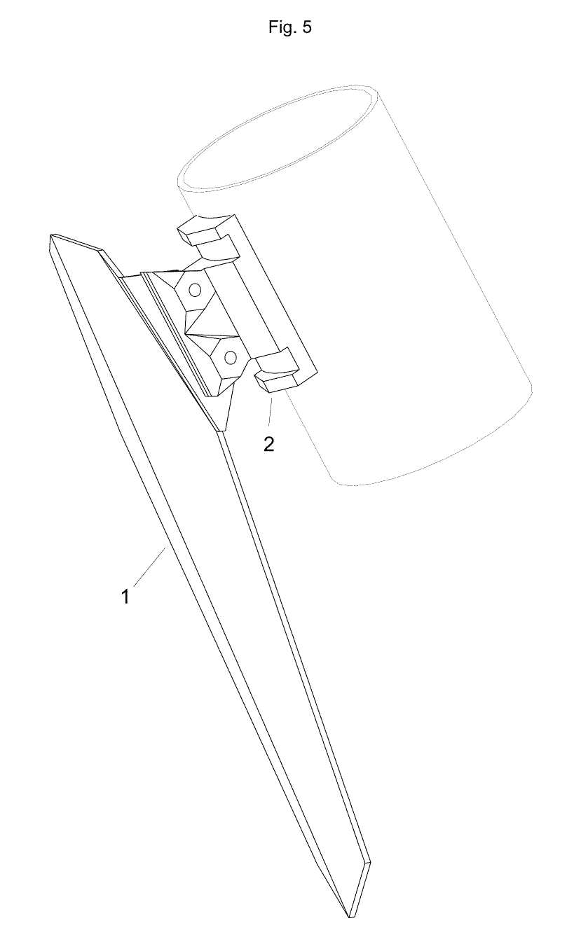

FIG. 5 illustrates axonometric of dust plate (straight) and mount A, with downtube.

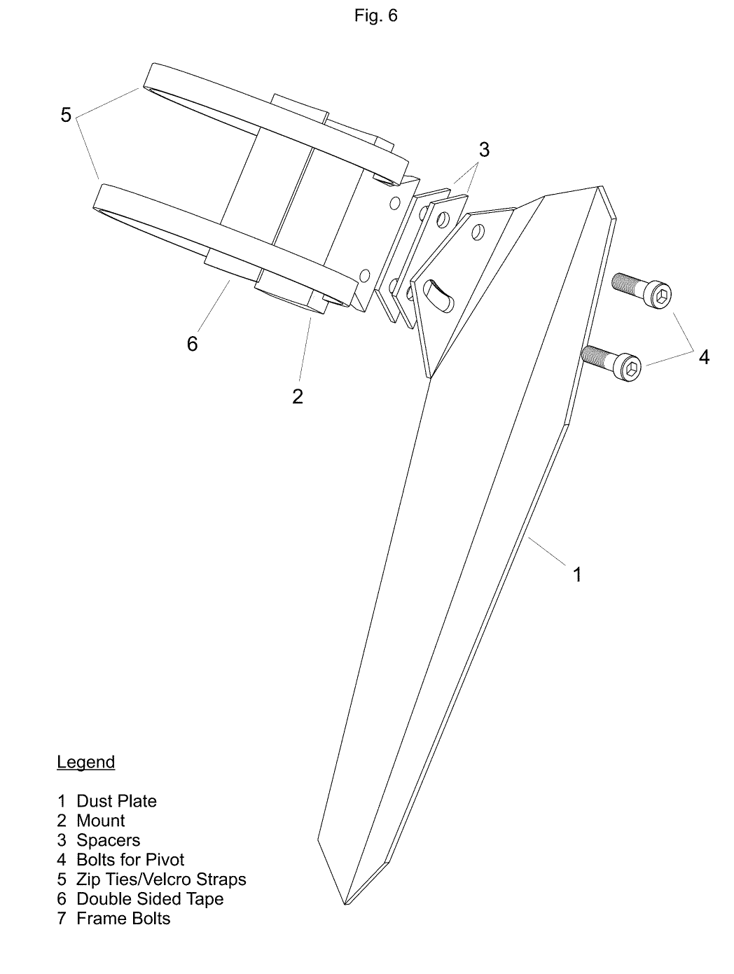

FIG. 6 illustrates exploded axonometric of dust plate (straight) and mount A, with legend.

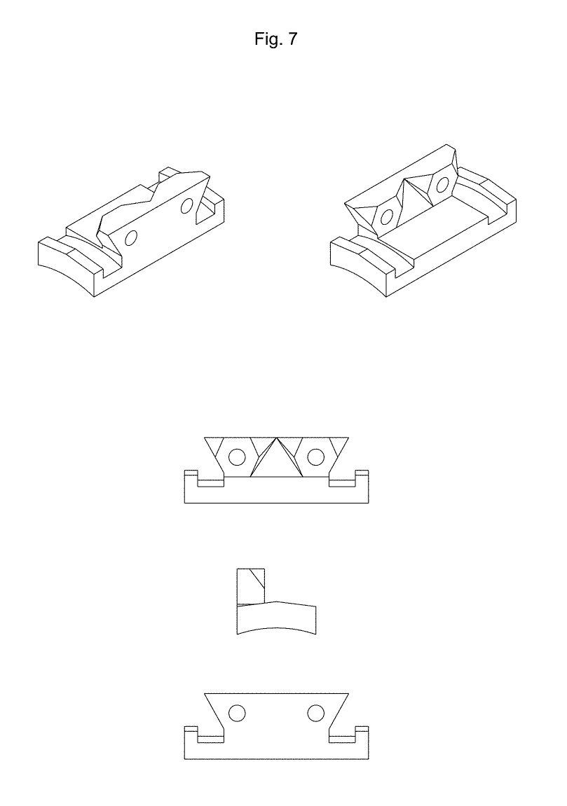

FIG. 7 illustrates bottom mount A (self tapping) of downtube.

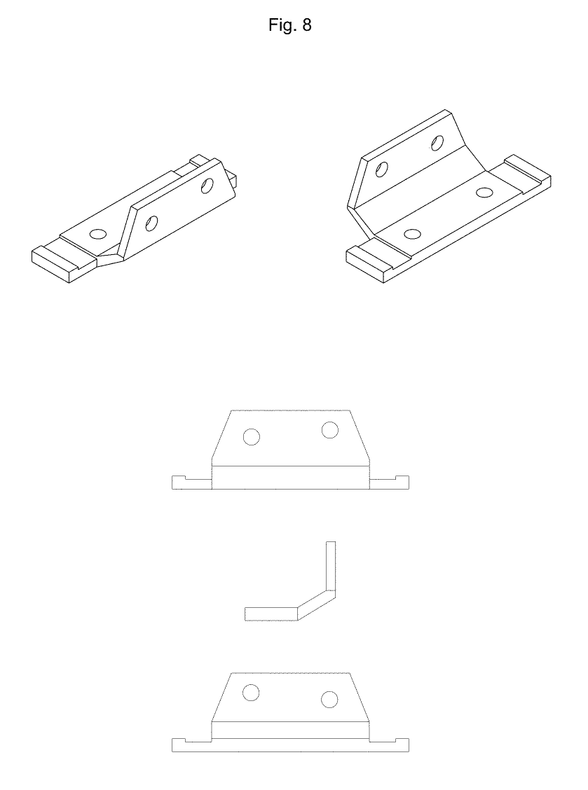

FIG. 8 illustrates bottom mount B (frame bolts/tie wrap) of downtube.

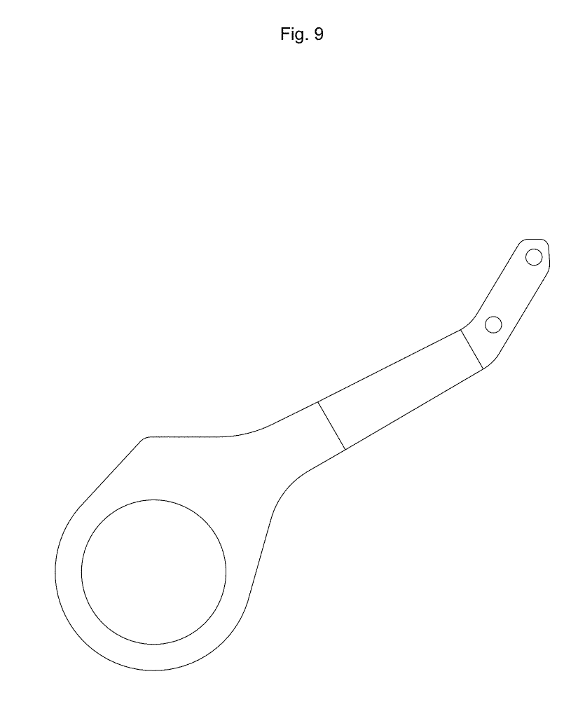

FIG. 9 illustrates bottom bracket mount.

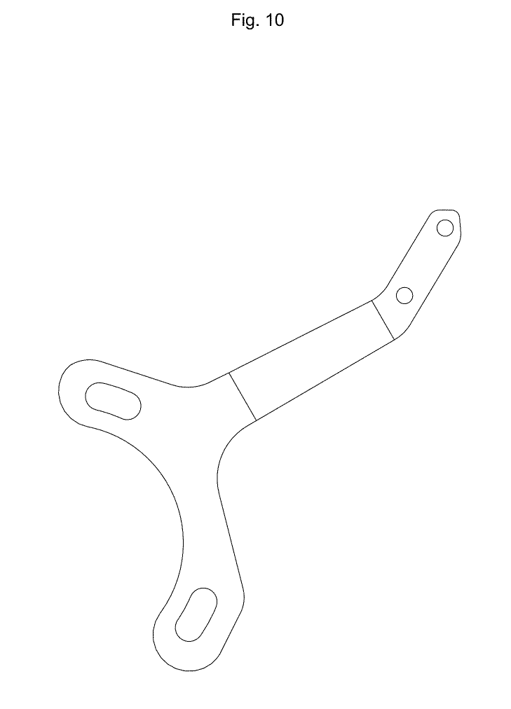

FIG. 10 illustrates ISCG-05 mount.

The dust plate and mount allows access to service the crank or chain illustrated in FIG. 1.

In FIG. 3 a side to side adjustment can be seen by adding or removing the spacers illustrated.

The tapered V-shape of the plate in FIG. 5 and FIG. 6 was designed to maximize dirt displacement while maintaining aerodynamics.

Note: All mounts may require a slightly narrower dust plate to provide crankarm clearance on different bicycles.

### DETAILED DESCRIPTION OF THE INVENTION

This dust plate is designed to reduce the amount of airborne particles (i.e. dirt, mud, water, etc. . . . ) from entering the drivetrain of a bicycle caused by the forward moving front tire or drafting while maintaining access to service the crank and/or chain. The tapered V-shape design helps redirect the particles away from the drivetrain with aerodynamics in mind.

It is to be attached to a bicycle's downtube or bottom bracket area and sits in front of the chainring (crank).

It can be adjusted: side to side for crank clearance by adding or removing the spacers, front to back by loosening the bolts and pivoting the plate (which also provides additional chainring clearance).

1. A dust plate mounted to a downtube or bottom bracket area that is located in front of the chainring (crank) reduces air borne particles from entering the drivetrain produced by a forward moving front tire.

2. Adjustable to provide chain and crank clearance.

3. The adjustment of claim 2, additional chain clearance is provided by loosening the bolts and pivoting the plate front to back.

4. The adjustment of claim 2, crank clearance is provided by adding or removing spacers that allow a side to side movement.
